(19) United States
(12) Patent Application Publication
(10) Pub. No.: US 2025/0053711 A1
(43) Pub. Date: Feb. 13, 2025

(54) METHOD FOR DETERMINING BATTERY DESIGN PARAMATERS USING NEURAL NETWORK MODEL

(71) Applicant: GIST(Gwangju Institute of Science and Technology), Gwangju (KR)

(72) Inventors: Heyong Jin KIM, Gwangju (KR); Kyoo Bin LEE, Gwangju (KR); Hyeong Hun PARK, Gwangju (KR); Joo Soon LEE, Gwangju (KR)

(73) Assignee: GIST(Gwangju Institute of Science and Technology), Gwangju (KR)

(21) Appl. No.: 18/636,582

(22) Filed: Apr. 16, 2024

(30) Foreign Application Priority Data
Aug. 11, 2023 (KR) 10-2023-0105419

(51) Int. Cl. G06F 30/27; G06N 3/08

(52) U.S. Cl. CPC G06F 30/27; G06N 3/08

(57) ABSTRACT

The present disclosure relates to a method for determining battery design parameters that satisfy all of current rate (C-rate)-specific target capacities using a neural network model. A method for determining battery design parameters according to an embodiment of the present disclosure includes: training a neural network model with correlations between design parameters of a battery and current rate-specific capacities; creating profiles of current rate-specific capacities corresponding to design parameters, respectively, by inputting design parameters sampled within preset ranges into the neural network model; and determining at least one group of design parameters satisfying all of current rate-specific target capacity conditions on the basis of the profiles.

### CROSS REFERENCE TO RELATED APPLICATION

The present application claims priority to Korean Patent Applications No. 10-2023-0105419, filed Aug. 11, 2023, the entire contents of which are incorporated herein for all purposes by this reference.

### BACKGROUND

### Technical Field

The present disclosure relates to a method for determining battery design parameters that satisfy all of current rate (C-rate)-specific target capacities using a neural network model.

### Description of the Related Art

Various countries are replacing internal-combustion engine vehicles with electric vehicles to achieve carbon neutrality in 2050. The early electric vehicles have high prices and short distances to empty in comparison to internal combustion engine vehicles. However, as a lithium-ion battery can be produced in large quantities, the prices of electric vehicles fell and the energy density increased, so all types of electric vehicle have come into the market in the last about 10 years.

It is required to design optimal batteries for the uses of electric vehicles in order to secure additional competitiveness of electric vehicles. However, in the process of designing batteries, various design parameters such as the porosity, the loading level, the thickness, the tortuosity, the electrode composition, the NP ratio, and the positions and number of taps of batteries have influence on transmission of ions and electrons and the design parameters have a tradeoff relationship or a nonlinear relationship, so it is a very difficult subject to optimally design a battery.

Accordingly, it is required to develop a solution for effectively analyzing the influence of design parameters on the electrochemical performance of a battery and quantifying the manufacturing process of the battery on the basis of the analysis.

### SUMMARY

An objective of the present disclosure is to train a neural network model with a nonlinear relationship between various parameters, which are considered in the process of designing a battery, and the performance of the battery and to make it possible to design a battery having desired conditions using the neural network model.

The objectives of the present disclosure are not limited to those described above and other objectives and advantages not stated herein may be understood through the following description and may be clear by embodiments of the present disclosure. Further, it would be easily known that the objectives and advantages of the present disclosure may be achieved by the configurations described in claims and combinations thereof.

In order to achieve the objectives described above, a method for determining battery design parameters according to an embodiment of the present disclosure includes: training a neural network model with correlations between design parameters of a battery and current rate-specific capacities; creating profiles of current rate-specific capacities corresponding to design parameters, respectively, by inputting design parameters sampled within preset ranges into the neural network model; and determining at least one group of design parameters satisfying all of current rate-specific target capacity conditions on the basis of the profiles.

A neural network model is trained with nonlinear relations between various design parameters, which are considered in the process of designing a battery, and the performance of the battery and then parameters for designing a battery having desired performance are determined, whereby there is the advantage that it is possible to quantify a manufacturing process of a battery over the existing trial-and-error manner.

Detailed effects of the present disclosure in addition to the above effects will be described with the following detailed description for accomplishing the present disclosure.

### BRIEF DESCRIPTION OF THE DRAWINGS

The above and other objectives, features and other advantages of the present disclosure will be more clearly understood from the following detailed description when taken in conjunction with the accompanying drawings, in which:

FIG. 1 is a flowchart showing a method for determining battery design parameters according to an embodiment of the present disclosure;

FIG. 2 is a diagram showing a manufacturing process of battery cells;

FIG. 3 is a diagram showing a process of assembling battery cells into a battery pack;

FIGS. 4A and 4B are diagrams respectively showing the cross-sectional structures of a cathode and an anode produced in accordance with design parameters (a porosity, a thickness, and a loading level);

FIG. 5 is a diagram for explaining the operation of a neural network model;

FIGS. 6 and 7 are diagrams showing embodiments of a neural network model, respectively;

FIG. 8 is a diagram schematizing design parameters that are input into a neural network model and current rate-specific capacities output from the neural network model;

FIG. 9 is a diagram separately showing the capacities of a battery according to parameters for respective current rates;

FIG. 10 is a diagram showing regions satisfying a target capacity condition in a profile of a current rate-specific capacity corresponding to design parameters; and

FIG. 11 is a diagram schematizing at least one group of design parameters satisfying all of current rate-specific target capacity conditions.

### DETAILED DESCRIPTION

The objects, characteristics, and advantages will be described in detail below with reference to the accompanying drawings, so those skilled in the art may easily achieve the spirit of the present disclosure. However, in describing the present disclosure, detailed descriptions of well-known technologies will be omitted so as not to obscure the description of the present disclosure with unnecessary details. Hereinafter, exemplary embodiments of the present disclosure will be described with reference to accompanying drawings. The same reference numerals are used to indicate the same or similar components in the drawings.

Although terms “first”, “second”, etc. are used to describe various components in the specification, it should be noted that these components are not limited by the terms. These terms are used to discriminate one component from another component and it is apparent that a first component may be a second component unless specifically stated otherwise.

Further, when a certain configuration is disposed “over (or under)” or “on (beneath)” a component in the specification, it may mean not only that the certain configuration is disposed on the top (or bottom) of the component, but that another configuration may be interposed between the component and the certain configuration disposed on (or beneath) the component.

Further, when a certain component is “connected”, “coupled”, or “jointed” to another component in the specification, it should be understood that the components may be directly connected or jointed to each other, but another component may be “interposed” between the components or the components may be “connected”, “coupled”, or “jointed” through another component.

Further, singular forms that are used in this specification are intended to include plural forms unless the context clearly indicates otherwise. In the specification, terms “configured”, “include”, or the like should not be construed as necessarily including several components or several steps described herein, in which some of the components or steps may not be included or additional components or steps may be further included.

Further, the term “A and/or B” stated in the specification means that A, B, or A and B unless specifically stated otherwise, and the term “C to D” means that C or more and D or less unless specifically stated otherwise.

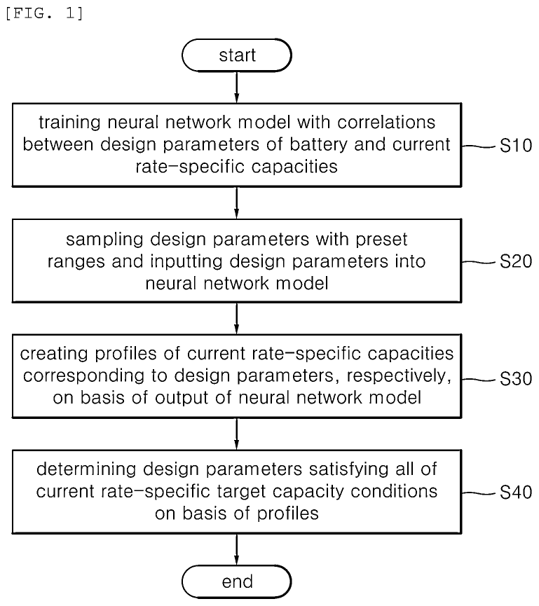

The present disclosure relates to a method for determining battery design parameters that satisfy all of target capacities of respective current rates (C-rate) using a neural network model. Hereafter, a method for determining a battery design parameter according to an embodiment of the present disclosure is described in detail with reference to FIGS. 1 to 11.

FIG. 1 is a flowchart showing a method for determining battery design parameters according to an embodiment of the present disclosure.

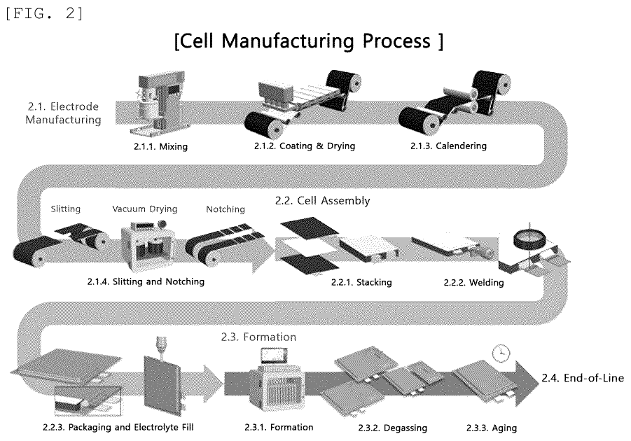

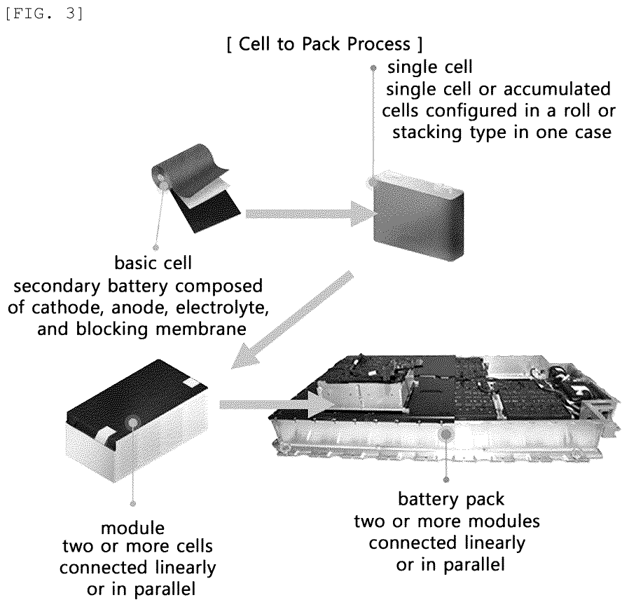

FIG. 2 is a diagram showing a manufacturing process of battery cells and FIG. 3 is a diagram showing a process of assembling battery cells into a battery pack.

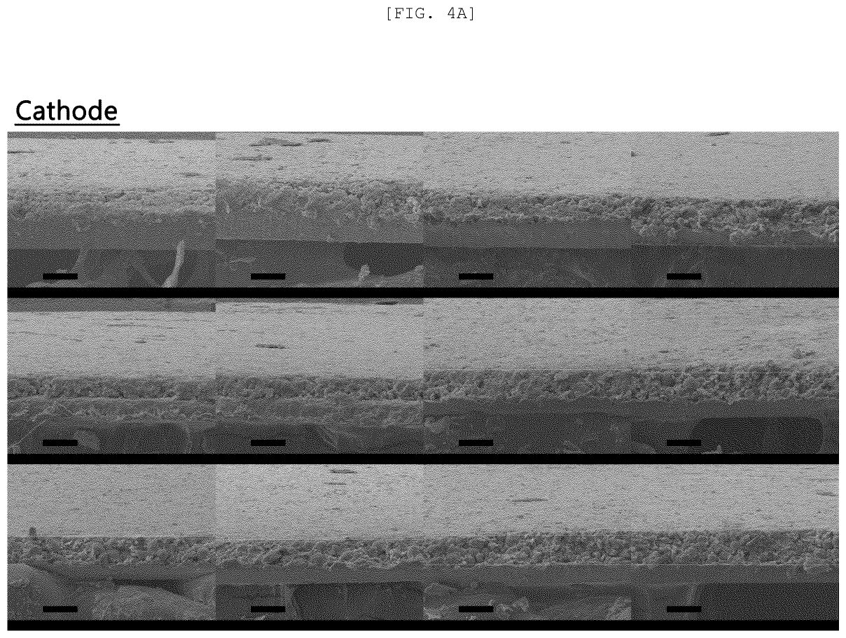

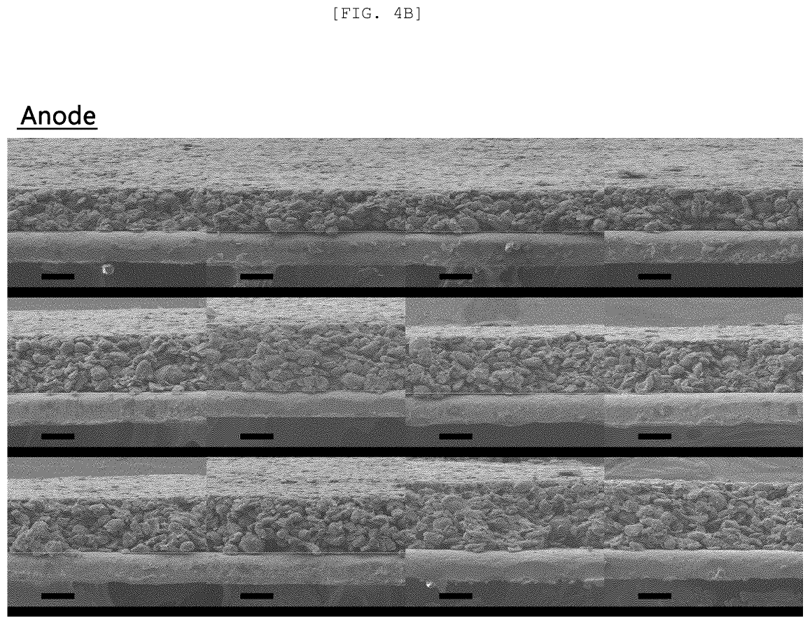

FIGS. 4A and 4B are diagrams respectively showing the cross-sectional structures of a cathode and an anode produced in accordance with design parameters (a porosity, a thickness, and a loading level).

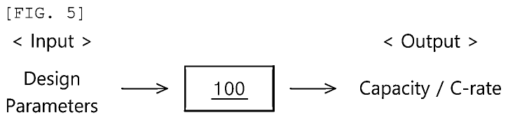

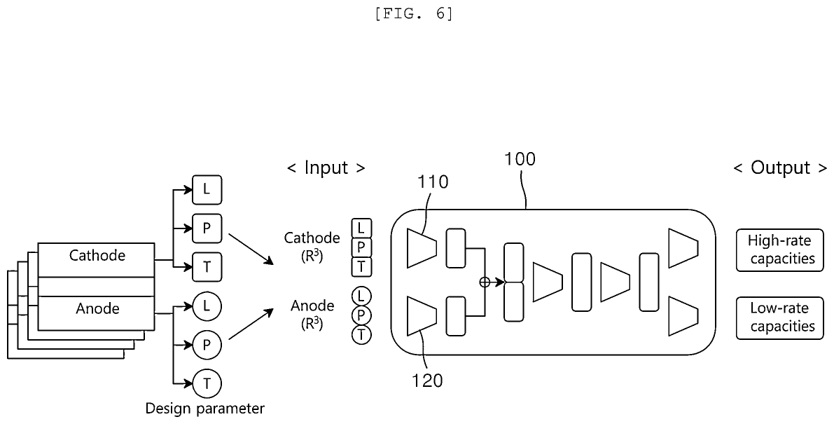

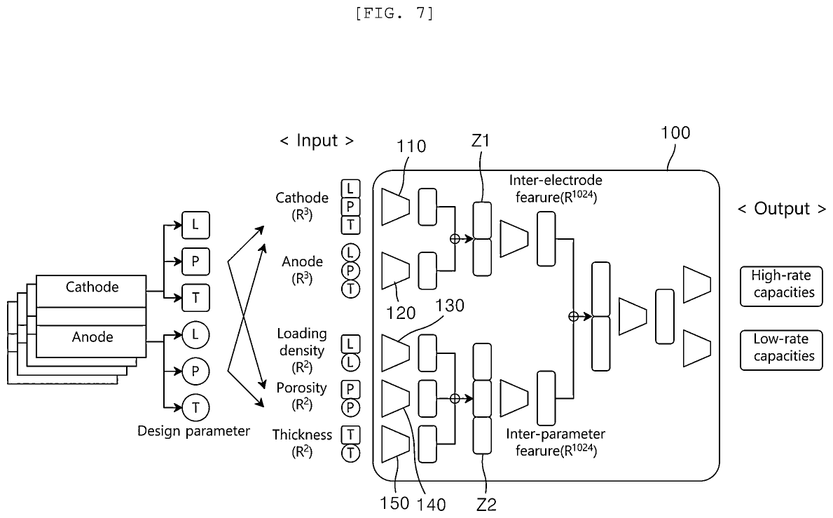

FIG. 5 is a diagram for explaining the operation of a neural network model. FIGS. 6 and 7 are diagrams showing embodiments of a neural network model, respectively.

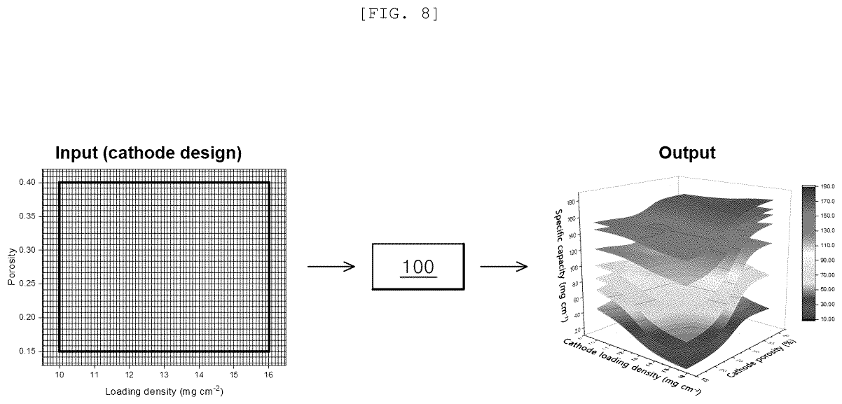

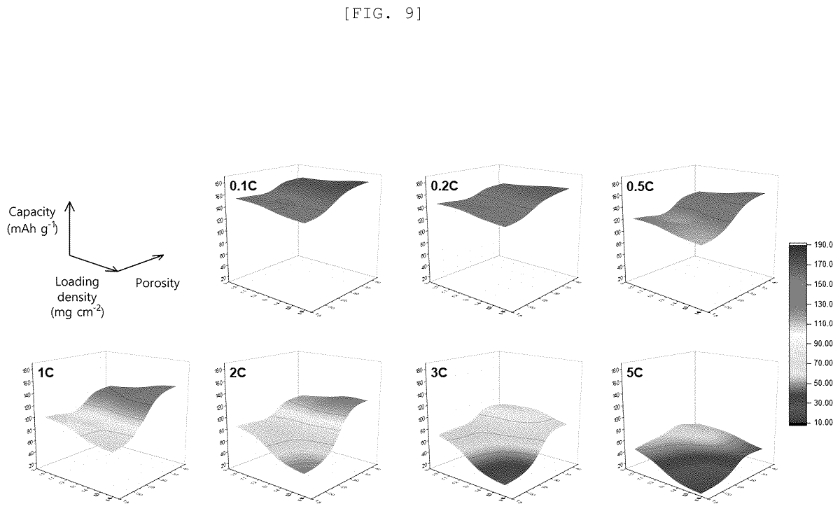

FIG. 8 is a diagram schematizing design parameters that are input into a neural network model and current rate-specific capacities output from the neural network model and FIG. 9 is a diagram separately showing the capacities of a battery according to parameters for respective current rates.

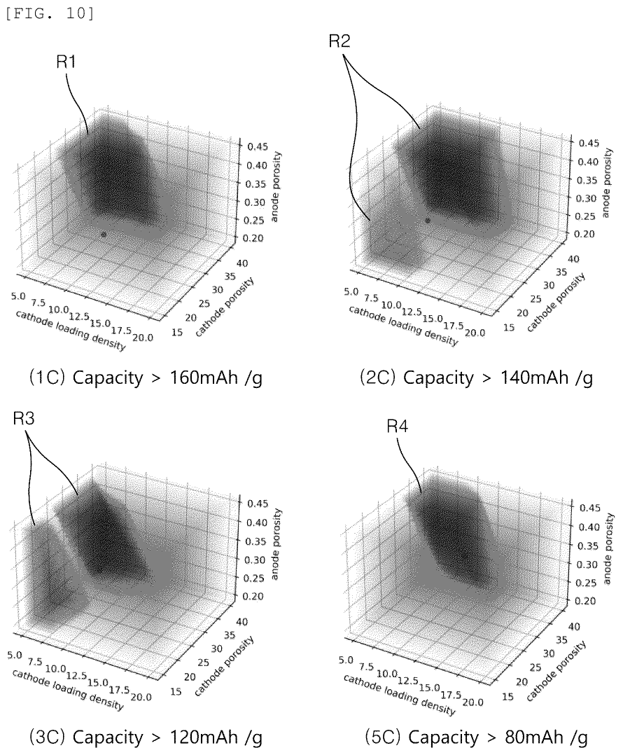

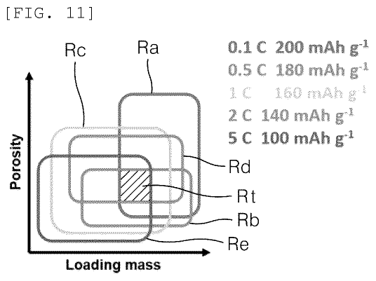

FIG. 10 is a diagram showing regions satisfying a target capacity condition in a profile of a current rate-specific capacity corresponding to design parameters and FIG. 11 is a diagram schematizing at least one group of design parameters satisfying all of current rate-specific target capacity conditions.

Referring to FIG. 1, a method for determining battery design parameters according to an embodiment of the present disclosure may include a step of training a neural network model with the correlations between battery design parameters and current rate-specific capacities (S10), a the design parameters within a step of sampling predetermined range and then inputting the design parameters into the neural network model (S20), a step of creating profiles of current rate-specific capacities corresponding to the design parameters, respectively, on the basis of output of the neural network model (S30), and a step of determining design parameters satisfying all of current rate-specific target capacity conditions on the basis of the profiles (S40).

However, the method for determining battery design parameters shown in FIG. 1 is based on an embodiment, the steps of the present disclosure are not limited to the embodiment shown in FIG. 1, and if necessary, some steps may be added, changed, or removed.

Meanwhile, the steps shown in FIG. 1 may be performed by a processor, and to this end, the processor may include at least one physical element of application specific integrated circuits (ASICs), digital signal processors (DSPs), digital signal processing devices (DSPDs), programmable logic devices (PLDs), field programmable gate arrays (FPGAs), a controller, and a micro-controller.

Hereafter, the steps shown in FIG. 1 are described in detail.

A processor can train a neural network model with the correlations between design parameters of a battery and current rate-specific capacities (S10).

The performance of a battery may nonlinearly change, depending on various design parameters that are applied to a design process and the processor can train a neural network model 100 with the nonlinear relations between the design parameters of the battery and the current rate-specific capacities.

In detail, referring to FIG. 2, a process of manufacturing the cells of a battery (Cell Manufacturing Process), in a broad meaning, may be composed of an electrode manufacturing process, a cell assembly process, and an formation process.

In this case, the size and composition of electrodes, a solidity ratio, viscosity, a coating gap, coating/drying speed and temperature, a pressing thickness, etc. may be changed as design parameters in the electrode manufacturing process, the number and positions of taps, the ratio between electrodes and an electrolyte, etc. may be changed as design parameters in the cell assembly process, and formation voltage, time, etc. may be changed as design parameters in the formation process.

Further, referring to FIG. 3, a large number of design parameters may be applied even to a process of packaging basic cells into a single cell, single cells into a module, and modules into a battery pack (Cell to Pack Process). The design parameters described above influence the performance of a battery and the tendencies thereof are nonlinear, so it is substantially impossible to recognize the influences of the parameters in advance and apply the influences to designing of battery.

The present disclosure may use the neural network model 100 to learn such nonlinear relations. In detail, a processor can apply supervised learning to the neural network model 100 by setting design parameters of a battery as input data of the neural network model 100 and setting current rate-specific capacities as output data of the neural network model 100.

Meanwhile, the parameters in the present disclosure may include at least one of the porosity, the thickness, the loading level or loading density, the composition, the tortuosity, the positions an number of taps, and the NP ratio of each of the cathode and the anode of a battery. However, for the convenience of description, an embodiment using a porosity, a thickness, and the loading level, which are known as having the largest influence on battery performance, as design parameters is described hereafter.

A processor can construct design parameters and current rate-specific capacities corresponding thereto into a training dataset. To this end, the processor can measure the capacity of a battery produced in accordance with design parameters for each current rate.

Referring to FIGS. 4A and 4B, in the present disclosure, 247 cathodes and 247 anodes having different porosities, thicknesses, and loading levels within a preset range are constructed and used into a training dataset, and FIGS. 4A and 4B show pictures of only cross-sections of 12 cathodes and anodes, respectively.

Battery cells each composed of a pair of cathode and anode, respectively, were used to measure capacities, and in the present disclosure, capacities according to 7 current rates (0.1 C, 0.2 C, 0.5 C, 1 C, 2 C, 3 C, and 5 C) were measured. Accordingly, in the present disclosure, a total of 247*7, that is, 1729 data were constructed into a training dataset.

Referring to FIG. 5, the processor can apply supervised learning to the neural network model 100 by setting the design parameters (e.g., a porosity, a thickness, and a loading level) constituting the training dataset as input data and setting current rate (C-rate)-specific capacities (e.g., capacities at 0.1 C, 0.2 C, 0.5 C, 1 C, 2 C, 3 C, and 5 C) corresponding to the design parameters as output data.

Accordingly, in the present disclosure, the neural network model 100 can perform a regression task, and to this end, the neural network model 100 may be implemented into various architectures based on an artificial neural network (ANN), a convolutional neural network (CNN), a recurrent neural network (RNN), and a Long Short Term Memory (LSTM).

In detail, the processor can set a loss function that is proportioned to the differences between an output value of the neural network model 100 receiving design parameters and the current rate-specific capacities substantially measured above, that is, |output value−current rate-specific capacity| and can train the neural network model 100 such that the loss function becomes minimum.

Meanwhile, the training method described above uses only the result of measuring a capacity one time, so tolerances that may be generated in the cell manufacturing or assembly process. In the present disclosure, it is possible to apply performance variations due to tolerances to training the neural network model 100 in consideration of the fact that the electrochemical performance of cells manufactured in accordance with substantially the same design parameters may be changed by tolerances.

In detail, the processor can collect current rate-specific capacities of a battery, which correspond to design parameters, for a preset number of cycles, respectively, and can set the averages of the current rate-specific capacities collected for the cycles, respectively, as output data of the neural network model 100 in the training process described above.

For example, the processor can collect current rate-specific capacities measured in accordance with 5 measurement cycles, respectively, for each of 247 battery cells exemplified above. The current rate-specific capacities measured at the cycles may be slightly different and the differences may reflect variations due to tolerances. The processor can calculate the average of them and can set the calculated average as output data in the process of training the neural network model 100.

Meanwhile, in the present disclosure, the neural network model 100 may be implemented as a Multi-Layer Perceptron (MLP) 100 including an input layer, a hidden layer, and an output layer.

In this case, the input layer can receive design parameters and the hidden layer can extract the features of design parameters and learn the relationships between the extracted features and current rate-specific capacities. In detail, parameters (weight and bias) of each of nodes constituting the hidden layer can be updated by repeated learning in accordance with the correlations between the features of design parameters and current rate-specific capacities. Meanwhile, the output layer can output current rate-specific capacities respectively through nodes corresponding to the number of the current rate-specific capacities, for example, 7 current rate includes 0.1 C, 0.2 C, 0.5 C, 1 C, 2 C, 3 C, and 5 C.

In an embodiment, the multi-layer perceptron 100 can receive design parameters for the cathode of a battery through a first node 110 of the input layer and parameters for the cathode of the battery through a second node 120 of the input layer.

Referring to FIG. 6, when parameters are the porosity P, the thickness T, and the loading level L for each of the cathode and the anode of a battery, the multi-layer perceptron 100 can receive a dataset [L, P, T] composed of the porosity, the thickness, and the loading level of the cathode through the first node 110 of the input layer and can receive a dataset [L, P, T] composed of the porosity, the thickness, and the loading level of the anode through the second node 120 of the input layer.

Meanwhile, as the output data of the multi-layer perceptron 100, high-rate specific capacities and low-rate specific capacities may be set. In this case, the high-rate specific capacities may be a dataset including capacities for 1 C, 2 C, 3 C, and 5 C and the low-rate specific capacities may be a dataset including capacities for 0.1 C, 0.2 C, and 0.5 C. Unlikely, the output layer of the multi-layer perceptron 100 may include 7 nodes that respectively output capacities for 0.1 C, 0.2 C, 0.5 C, 1 C, 2 C, 3 C, and 5 C.

Referring to FIG. 6 again, the multi-layer perceptron 100 can concatenate features extracted from the design parameters of the cathode and the anode and can learn the relationships between encoded features and current rate-specific capacities while repeatedly encoding the concatenated features. That is, since the structure described above is provided, it is possible to consider the general features of the design parameters of a cathode and an anode when training the multi-layer perceptron 100.

In another embodiment, the multi-layer perceptron 100 can receive design parameters for the cathode of a battery through a first node 110 of the input layer and parameters for the cathode of the battery through a second node 120 of the input layer, and additionally, can receive pairs of design parameters of the cathode and the anode through an additional node of the input layer.

Referring to FIG. 7, when parameters are the porosity P, the thickness T, and the loading level L for each of the cathode and the anode of a battery, the multi-layer perceptron 100 can receive a dataset [L, P, T] composed of the porosity, the thickness, and the loading level of the cathode through the first node 110 of the input layer and can receive a dataset [L, P, T] composed of the porosity, the thickness, and the loading level of the anode through the second node 120 of the input layer.

In addition, the multi-layer perceptron 100 can receive a pair of porosities for the cathode and the anode through a third node 130 of the input layer, can receive of a pair of thickness for the cathode and the anode through a fourth node of the input layer 140, and can receive of a pair of loading levels for the cathode and the anode through a fifth node 150 of the input layer.

The multi-layer perceptron 100 can create a first latent vector Z1 by combining the features extracted from the design parameters of the cathode and the anode and can create a second latent vector Z2 by combining the features extracted from the pairs of design parameters of the cathode and the anodes. Next, the multi-layer perceptron 100 can encode and then combine the first and second latent vectors Z1 and Z2 and can learn the relationships between the combined latent vector and the current rate-specific capacities.

Since this structure is provided, it is possible to generally consider the features between electrodes (inter-electrode features) and the features between the pairs of design parameters (inter-parameter features) when training the multi-layer perceptron 100.

Further, when design parameters are a porosity P, a thickness T, and a loading level L, any one of the three elements can be mathematically extracted from the other two, so any one of the three elements that are input to the first or second node 120 may be disregarded in the multi-layer perceptron 100. However, when the multi-layer perceptron 100 is designed as shown in FIG. 7, pairs of design parameters having no correlation may be individually input through the third to fifth nodes 130, 140, and 150, and consequently, all of elements in design parameters may be generally considered in training of the multi-layer perceptron 100.

When the neural network model 100 finishes being trained, the processor can sample design parameters within a preset range and input the sampled design parameters into the neural network model 100. In this case, it may be preferable that the range in which design parameters are sampled is set within a range in which elements (e.g., a porosity, a thickness, and a loading level) in the design parameters were changed when a training dataset for training the neural network model 100 is constructed in step S10 in order to achieve high estimation performance of the neural network model 100.

The neural network model 100 may have knowledge about the relationships between design parameters and current rate-specific capacities in accordance with the training of step S10. Accordingly, even though a design parameter not used for training is input, the neural network model 100 can output a current rate-specific capacity that is estimated in accordance with the design parameter.

The processor can create a profile of each of the current rate-specific capacities corresponding to the design parameters, respectively, on the basis of the output of the neural network model 100 (S30). In other words, the processor can create profiles by defining the current rate-specific capacities output from the neural network model 100 for respectively elements in the design parameters input to the neural network model 100.

Hereafter, the operation of creating a profile by the processor is described in detail with reference to FIGS. 8 and 9, and it is assumed that design parameters that are input to the neural network model 100 are two kinds of a porosity and a loading level to visualizing the figures.

Referring to FIG. 8, the processor can sample a plurality of elements within ranges differently set for a plurality of elements in design parameters. For example, the processor can sample a loading level within a range of 10˜16 (mg/cm²) and can sample a porosity within a range of 15˜40%. Accordingly, a pair of sampled design parameters can be expressed as coordinates in a plane that are defined as a loading level and a porosity. Meanwhile, the sampling ranges of the loading level and the porosity are examples and sampling ranges can be freely set for respective elements in design parameters by users.

Next, the processor can recognize current rate-specific capacities corresponding to combinations, respectively, by inputting combinations of sampled elements, that is, [loading level and porosity] into the neural network model 100 and can create a profile by defining them for the elements, respectively. In detail, the neural network model 100 can output a current rate-specific capacity for each combination of elements and the processor can profile the current rate-specific capacity for each combination of elements that linearly changes by continuously sampling design parameters.

With reference to FIGS. 8 and 9, in detail, in step S10, the neural network model 100 can be trained to receive design parameters and output capacities for 0.1 C, 0.2 C, 0.5 C, 1 C, 2 C, 3 C, and 5 C. When design parameters are a loading level and a porosity as in this example, the processor can linearly sample and input the loading level and the porosity into the neural network model 100, and in this case, the current rate-specific capacities that are output from the neural network model 100 can be defined as 3D faces type for respective current rates (0.1 C, 0.2 C, 0.5 C, 1 C, 2 C, 3 C, and 5 C), as shown in FIG. 9. The processor can store a profile of the ‘[loading level and porosity]—current rate-specific capacity’ defined as described above into a memory.

The processor can determine at least one group of design parameters that satisfy all of current rate-specific target capacity conditions on the basis of the profiles created in accordance with the method described above. In this case, the current rate-specific target capacity conditions may be capacity conditions desired for respectively current rates and may be set as any values by users.

Since the larger the capacity at the current rates, the higher the performance of a battery, the processor can recognize design parameters for which the capacity of a battery is higher than target conditions set for respective current rates on the basis of the profile defined as ‘design parameter—current rate-specific capacity’, and can determine one group of design parameters that satisfy all of the target capacity conditions.

Referring to FIG. 10, in detail, a current rate-specific target capacity condition lay include a first condition set as 160 mAh/g at a current rate of 1 C, a second condition set as 140 mAh/g at a current rate of 2 C, a third condition set as 120 mAh/g at a current rate of 3 C, and a fourth condition set as 80 mAh/g at a current rate of 5 C. Meanwhile, it is assumed that design parameters are the loading level of a cathode, the porosity of the cathode, and the porosity of an anode in this example for visualization of figures.

The processor can recognize a plurality of sets of design parameters having a current rate-specific capacity higher than a target capacity condition on the basis of a profile. That is, as shown in FIG. 10, the processor can recognize [the loading level of a cathode, the porosity of the cathode, and the porosity of an anode] satisfying a first condition as a first region R1 and can recognize [the loading level of a cathode, the porosity of the cathode, and the porosity of an anode] satisfying a second conditions as a second region R2. Similarly, the processor can recognize [the loading level of a cathode, the porosity of the cathode, and the porosity of an anode] satisfying a third condition as a third region R3 and can recognize [the loading level of a cathode, the porosity of the cathode, and the porosity of an anode] satisfying a fourth condition as a fourth region R4.

Next, the processor can determine the intersection of a plurality of sets of design parameters included in the regions, respectively, as at least one group of design parameters satisfying all of current rate-specific target capacity conditions.

In order to help understand the present disclosure, referring to FIG. 11 in which regions satisfying current rate-specific target capacity conditions are shown in a 2D target capacity plane, when current rate-specific conditions are set as 200 mAh/g, 180 mAh/g, 160 mAh/g, 140 mAh/g, and 100 mAh/g at 0.1 C, 0.5 C, 1 C, 2 C, and 5 C, respectively, the regions of design parameters (e.g., [loading level and porosity]) satisfying the conditions may be recognized as Ra, Rb, Rc, Rd, and Re.

The processor can determine Rt that is the intersection of the sets of design parameters (Ra, Rb, Rc, Rd, and Re) defined as the regions, respectively, as one group of design parameters satisfying all of capacity conditions set for the current rates, respectively, and can output information about Rt through a display or provide the information to a user terminal. A user can design a battery in consideration of the design parameters included in Rt and a battery produced in this way can have performance exceeding a desired capacity for each current rate.

As described above, a neural network model is trained with the nonlinear relations between various design parameters, which are considered in the process of designing a battery, and the performance of the battery and then parameters for designing a battery having desired performance are determined, whereby there is the advantage that it is possible to quantify a manufacturing process of a battery over the existing trial-and-error manner.

Although the present disclosure was described with reference to the exemplary drawings, it is apparent that the present disclosure is not limited to the embodiments and drawings in the specification and may be modified in various ways by those skilled in the art within the range of the spirit of the present disclosure. Further, even though the operation effects according to the configuration of the present disclosure were not clearly described with the above description of embodiments of the present disclosure, it is apparent that effects that can be expected from the configuration should be also admitted.

What is claimed is:

1. A method for determining battery design parameters, the method comprising:
training, by a processor, a neural network model with correlations between design parameters of a battery and current rate-specific capacities;
creating, by the processor, profiles of current rate-specific capacities corresponding to design parameters, respectively, by inputting design parameters sampled within preset ranges into the neural network model; and
determining, by the processor, at least one group of design parameters satisfying all of current rate-specific target capacity conditions on the basis of the profiles.

2. The method of claim 1, wherein the design parameters include at least one of a porosity, a thickness, a loading level, a composition, a tortuosity, a solidity ratio, viscosity, a coating gap, coating speed and temperature, drying speed and temperature, a pressing thickness, positions and the number of taps, an NP ratio, and formation voltage and time of each of a cathode and an anode of the battery.

3. The method of claim 1, wherein the training includes applying supervised learning to the neural network model by setting the design parameters of the battery as input data of the neural network model and setting the current rate-specific capacities as output data of the neural network model.

4. The method of claim 3, wherein the training includes collecting current rate-specific capacities of the battery that correspond to the design parameters for each of a preset number of cycles and setting averages of current rate-specific capacities collected at the cycles, respectively, as output data of the neural network model.

5. The method of claim 1, wherein the neural network model is a Multi-Layer Perceptron (MLP).

6. The method of claim 5, wherein the multi-layer perceptron receives parameters for the cathode of the battery through a first node of an input layer and receives parameters for the anode of the battery through a second node of the input layer.

7. The method of claim 6, wherein the multi-layer perceptron receives pairs of design parameters of the cathode and the anode through an additional node of the input layer.

8. The method of claim 1, wherein the creating of profiles includes:
sampling a plurality of elements in the design parameters within ranges differently set for the plurality of elements;
recognizing current rate-specific capacities corresponding to combinations of the sampled elements by inputting the combinations into the neural network model; and
creating the profiles by defining the current rate-specific capacities for the elements, respectively.

9. The method of claim 1, wherein the determining of design parameters includes:
recognizing a plurality of sets of design parameters having a current rate-specific capacity higher than the target capacity on the basis of the profiles; and
determining an intersection of the plurality of sets of design parameters as at least one group of design parameters.
